(19) United States
(12) Patent Application Publication
(10) Pub. No.: US 2006/0147571 A1
(43) Pub. Date: Jul. 6, 2006

(54) Method and apparatus for completely or partly covering at least one electronic component with a compound

(75) Inventors: Marinus F. J. Evers, Heeze (NL); Antonie van Weelden, Groessen (NL)

Correspondence Address: PILLSBURY WINTHROP SHAW PITTMAN, LLP, P.O. BOX 10500, MCLEAN, VA, 22102, US

(73) Assignee: OTB GROUP B.V., EB Eindhoven (NL)

(21) Appl. No.: 10/524,529

(22) PCT Filed: Aug. 12, 2003
(86) PCT No.: PCT/NL03/00577

§ 371 Date: Sep. 12, 2005

(30) Foreign Application Priority Data
Aug. 13, 2002 (NL) 1021266

(51) Int. Cl. B29C 45/14

(52) U.S. Cl. 425/116; 425/129.1

(57) ABSTRACT

A method and apparatus for at least partly covering at least one electronic component with compound, the apparatus being provided with a first mold half and a second mold half, the first mold half being moveable relative to the second mold half, while means are provided for placing an electronic component on a mold half for inclusion of this component in a mold cavity defined by the two mold halves, the first mold half being provided with a number of actuators with the aid of which the position of the first mold half relative to the second mold half is continuously and accurately regulable, while the distance between the two mold halves is continuously regulated and, if desired, adjusted during the two mold halves being moved towards each other and during their being held in a position when moved towards each other.

The invention relates to a method according to the preamble of claim 1.

The invention also relates to an apparatus according to the preamble of claim 11.

Such a method and apparatus are known from U.S. Pat. No. 6,346,433 and EP-A-0 971401.

The drawbacks of the known method and apparatus are inter alia that in them, the mold halves in the position when moved towards each other are pressed together with force. Accordingly, in technical jargon, the term pressing is used. The distance between the mold halves is determined by the mutual contacting surfaces of the mold halves, i.e. the surfaces which, with the mold in closed condition, are pushed against each other. Under the influence of various circumstances, varying from preparation tolerances, material stresses in the mold, tolerances on the carrier of the product to be encapsulated, and external circumstances such as, for instance, temperature and the like, it may occur that the mold halves are not or cannot be properly pressed together. Then, the encapsulating material will fill up this space at those locations where there is room to that end, and bleed and flash occur. Another consequence is that the mold cavity dimensions can deviate. In particular with electronic components provided with a chip with sensor function or contact surfaces (so-called solder bumps or upwardly or downwardly protruding contact points) such a deviating mold cavity dimension can result in the sensor or the bumps being covered with compound, which renders the electronic component unusable.

The invention contemplates a method and an apparatus with which these problems are remedied.

To this end, the method and apparatus described in the opening paragraph are characterized by the features of claims 1 and 11, respectively.

The position controlled regulation of the mold halves relative to each other makes it possible to adjust away deviations occurring due to external factors. The necessity of pressing the mold halves together with great force is thereby eliminated. As a result, an apparatus according to the invention can be constructed to be much lighter than the known presses for covering electronic components with compound. Generally, a lighter construction allows for the mold halves to be moved more rapidly relative to each other, thereby obtaining a greater capacity. Moreover, as a rule, lighter constructions are advantageous from a point of view of costs. Another advantage is that due to the position controlled actuators and the associated control, an operation is obtained with which the rate of the mold having moving towards each other can be accurately regulated; thus, for instance, the flow pattern and the flow rate of the compound over the electronic compound can be influenced.

Furthermore, by working with several actuators, the plan parallelism of the two mold halves relative to each other can each time be adjusted if necessary. Moreover, with the method and apparatus according to the invention, it can be ensured that with the mold halves in the position when moved towards each other, for instance bumps or such upwardly or downwardly protruding contact points of the electronic component abut against one of the mold halves and therefore remain clear of compound when the compound cures. The mold halves can be covered or not be covered with film to simplify keeping the contact surfaces clear and keeping the mold half (halves) clear from compound. The film side contacting the contacts points can be provided or not be provided with an adhesive layer.

By accurately positioning the mold halves relative to each other, the impression of the film can be very well controlled and forces on the chip or carrier are minimal. In this manner, it can be ensured that the electronic component need not undergo a finishing operation for removing compound from the contact points or bumps. The functional area of a sensor chip will remain bleed- and flash-free.

Optionally, in addition to the position control of the mold halves, force feedback control can take place. The apparatus can for instance “feel” whether the moveable mold half has already contacted the electronic component. However, it is self-evident that also different methods and elements can be used to ensure a desired distance between the mold halves. For instance, sensors for determining the distance between the mold halves can be provided on the mold halves, optionally at different positions. The signals of these sensors can then be used for adjusting the mutual position of the mold halves relative to each other.

According to a further elaboration of the invention, the method and the apparatus are characterized by the features of claims 2 and 12, respectively.

As the mold halves are held at a small distance from each other, a certain position control range is maintained. It is self-evident that measures have to be taken to prevent compound from undesirably flowing away between the mold halves. This can for instance be effected by allowing the distance between the mold halves to be very small, for instance in the order of some micrometers. On the other hand, it is also possible that one of the mold halves is provided with a resiliently arranged ring surrounding the mold cavity. Such resilient rings are also known from molds for manufacturing CD's and DVD's and are indicated in that field of technology with the term venting ring. Such a resiliently arranged venting ring is connected to the one mold half and, with the mold halves in the position when moved towards each other, contacts the other mold half. As the ring is arranged to be resilient, this ring does not further influence the relative distance between the mold halves. This relative distance—and hence the dimensions of the mold cavity—is determined by the control which controls the actuators in a desired manner. The actuators can comprise, for instance, screw spindles driven by servomotors. Linear servomotors are a possibility too. It is of importance that with the actuators, a continuous position control range is obtained. With modern high performance servocontrols, optionally supplemented with a force feedback control superposed thereon, an exceptionally accurate and flexible apparatus can be obtained.

When encapsulating semiconductor products, it is of importance that during filling, the filled material is brought to a high pressure. In electromechanical presses used nowadays, the closing force is applied already from the moment of closing up.

By measuring the viscosity of the compound and the pressure in the compound, the force of compression of the compound can be regulated.

Further elaborations of the invention are described in the subclaims and will be further elucidated hereinafter with reference to the drawing.

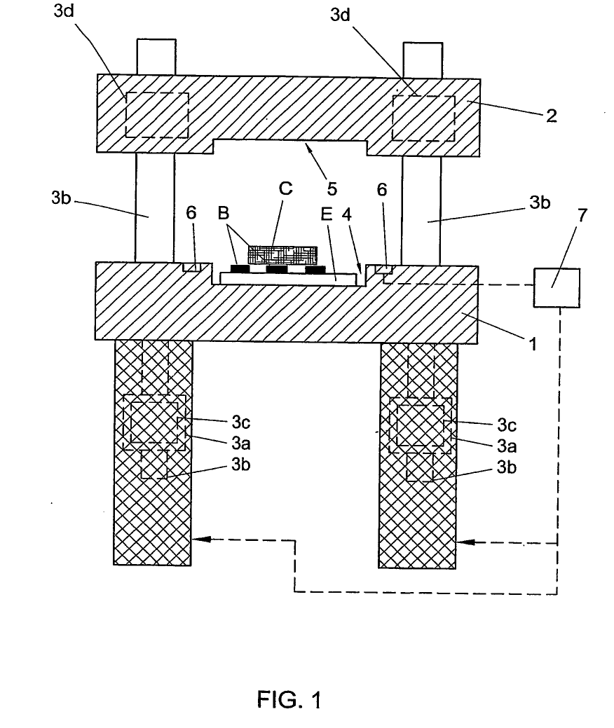

FIG. 1 shows a schematic cross sectional view of a first exemplary embodiment of an apparatus according to the invention with mold halves moved apart;

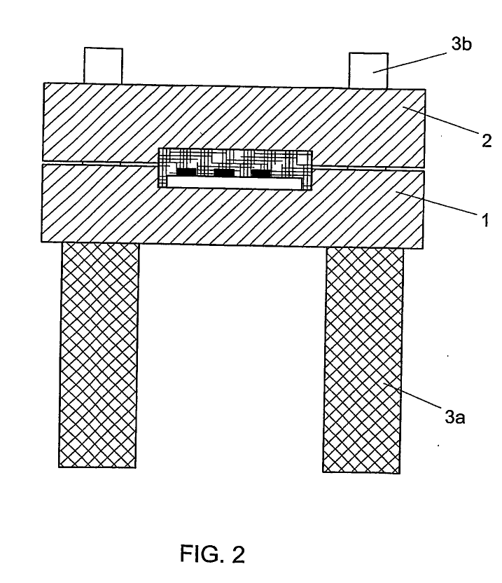

FIG. 2 shows a cross-sectional view of the exemplary embodiment represented in FIG. 1 with mold halves moved towards each other;

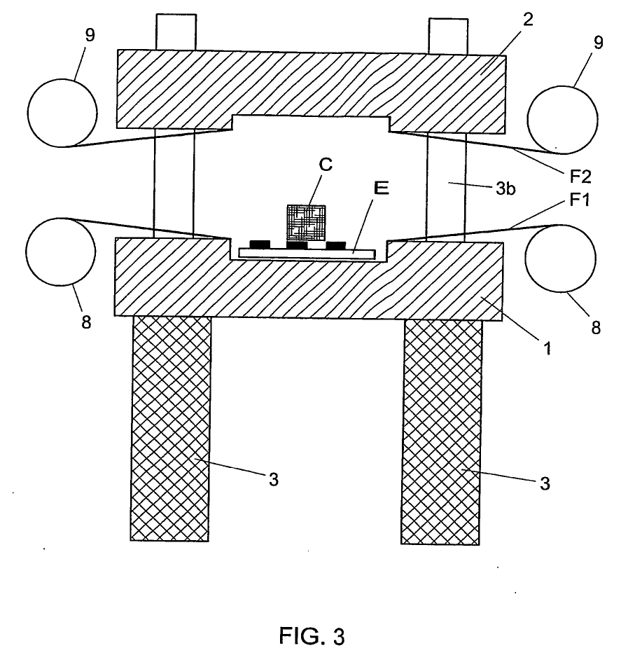

FIG. 3 shows a cross-sectional view of a second exemplary embodiment with mold halves moved apart;

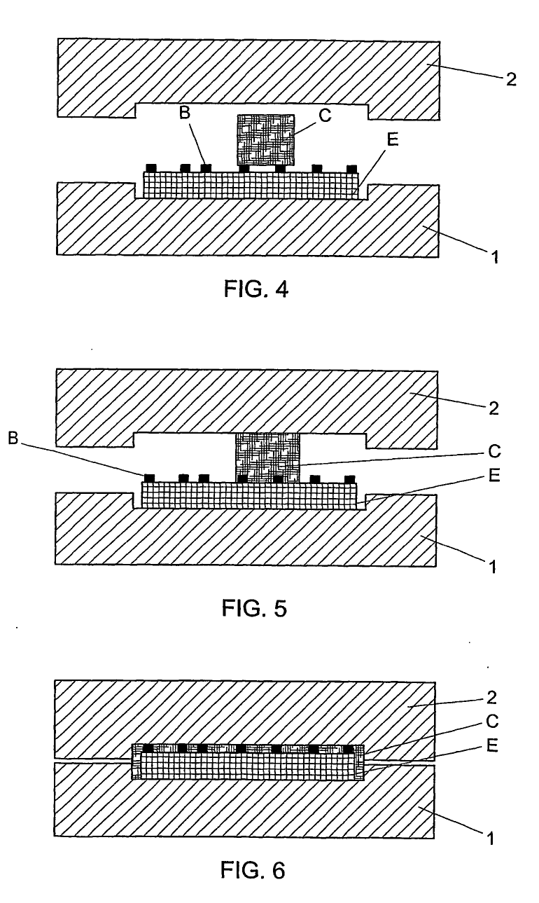

FIGS. 4-6 show the various stages of two mold halves being moved towards each other; and

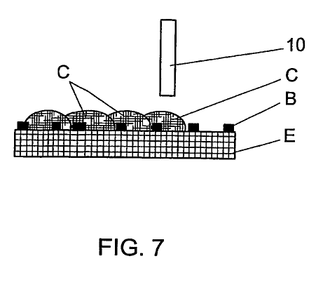

FIG. 7 shows a side view of the application of a compound on an electronic component.

All Figures show a first mold half 1 and a movably arranged second mold half 2. In the exemplary embodiment shown, the position of the second mold half is regulated by four actuators 3 connected to the corner points of the second mold half 2. The actuators 3 can for instance comprise servomotors 3a, each driving a screw spindle 3b via a screw spindle nut 3c. Upon rotation of the screw spindle nut 3c, the associated screw spindle 3b undergoes an axial displacement. The second mold half 2 is provided with bearings 3d in which the extremities of the screw spindles 3b are bearing mounted.

In the present exemplary embodiment, the mold halves 1, 2 are each provided with a recess 4, 5 together defining a mold cavity when the mold halves 1, 2 are in the position when moved towards each other. In the recess 4 of the first mold half 1, an electronic component E is placed. The electronic component E can comprise, for instance, a wafer with a number of chips formed thereon. However, with the method and apparatus according to the invention, other electronic components too can at least partly be covered with a compound. In the present case, the electronic component is provided with bumps or upwardly protruding contact points B.

In FIG. 1, an amount of compound C has been placed on top of the electronic component E. By moving the mold halves 1, 2 towards each other, the compound is compressed and it flows over the electronic component E, thereby completely filling the mold cavity 4, 5 with compound C. The position in which the mold halves have been moved towards each other is shown in FIG. 2. It is clearly visible that the screw spindles 3b have been taken up further into the actuator housing 3. It is also clearly visible that the mold halves 1, 2 are not pressed onto each other but that between them, a certain distance is maintained, so that the relative positions of the mold halves 1, 2 can be continuously adjusted by the actuators 3. Adjustment can take place on the basis of, for instance, signals provided by sensors. Accurate proximity sensors 6 could serve to this end. Optionally, in the screw spindles 3b or the actuator housings 3, force detectors can be included with which axial forces are detected. Via a force feedback control superposed on the position control, the position controlled actuators could further adjust the relative position of the mold halves 1, 2. It is self-evident that for all this, a control 7 is required, connected to the actuators 3 and the optional sensors 6. The compound can, for instance, be a thermoset which is cured at a mold temperature of 80-180° C., depending on the sort of compound used.

The second exemplary embodiment represented in FIG. 3 shows a similar apparatus wherein a film supply and discharge device 8 for the first mold half 1 and a film supply and discharge device 9 for the second mold half 2 are shown. The film F1, F2 can, for instance, be a release film effecting the easy release of the compound C from the mold cavities 4, 5. Moreover, the lower film F1 can also be used for supply and discharge of the electronic component E.

FIGS. 4-6 show the different phases of the mold halves moving towards each other. From FIG. 6 too, it appears once more that the mold halves 1, 2 do not contact each other in the position when moved towards each other, so that their relative position remains adjustable. In the exemplary embodiment shown this is of importance because then, it can be effected that the inside surface of the recess 5 in the second mold half 2 can be positioned accurately against the bumps B of the electronic component E. This prevents contamination of the upper side of these bumps by compound.

Finally, FIG. 7 schematically shows in what manner an electronic component E can be provided with compound C with the aid of an inkjet head 10. The electronic component thus provided with compound can be placed into the mold cavity to have the compound cure in the desired final shape there.

It will be clear that in an apparatus and method according to the invention, one of the mold parts can move, a part which may or may not carry the component E, while also both parts may be movable.

It will be clear that the invention is not limited to the exemplary embodiment described, but that various modifications are possible within the framework of the invention.

For instance, provisions can be present for automatically placing and discharging a component into and from the mold halves, respectively. Compound supply provisions other than those shown in the Figures are possible too. An alternative is described for instance in EP-A-0971401, the content of which is understood to be incorporated herein by reference. For that matter, the teaching of U.S. Pat. No. 6,346,433 is also understood to be incorporated herein by reference.

1. A method for completely or partly covering at least one electronic component with a compound, wherein in a suitable order, the following steps are traversed:
a) the at least one electronic compound is placed on a mold half;
b) the electronic compound is completely or partly covered with the compound;
c) a second mold half which is moveable relative to the first mold half is moved in the direction of the first mold half;
characterized in that
e) the distance between the two mold halves is continuously regulated and, if desired, adjusted during the two mold halves being moved towards each other and during the two mold halves being held in a position when moved towards each other during the curing of the compound.

2. A method according to claim 1, wherein, in the position when moved towards each other, the mold halves are held at a small distance from each other, so that in the position when moved towards each other too, a certain position control range is maintained.

3. A method according to claim 1 or 2, wherein step b) takes place after the mold halves have been brought into the position when moved towards each other.

4. A method according to claim 3, wherein the compound is injected into the mold cavity.

5. A method according to claim 3, wherein the compound is placed in the mold cavity and during the mold halves being moved towards each other is compressed so as to be spread in the mold cavity.

6. A method according to claim 1 or 2, wherein step b) takes place before the mold halves have been brought into the position when moved towards each other.

7. A method according to claim 6, wherein the compound is placed on the electronic component and, together with the component, is placed on the mold half.

8. A method according to claim 7, wherein the placement of the compound is effected by an inkjet technique, so that the compound is placed on the desired positions on the electronic component.

9. A method according to any one of the preceding claims, wherein a film is placed between the electronic component and at least one mold half.

10. A method according to claim 9, wherein the film also serves for supplying and/or discharging the electronic component into or from the mold cavity, respectively.

11. An apparatus for carrying out the method according to any one of the preceding claims, wherein the apparatus is provided with a first mold half and a second mold half, wherein the first mold half is moveable relative to the second mold half, while means are provided for placing an electronic component on a mold half for inclusion of the component in a mold cavity defined by the two mold halves, characterized in that the first mold half is provided with a number of actuators with the aid of which the position of the first mold half relative to the second mold half is continuously and accurately regulable, the apparatus being provided with a control for regulating the positions of said number of actuators, so that the distance between the two mold halves is continuously regulated, and, if desired, adjusted during the two mold halves being moved towards each other and during the two mold halves being held in a position when moved towards each other.

12. An apparatus according to claim 11, wherein the control is arranged for holding the two mold halves at a small distance from each other in the position when moved towards each other, so that in the position when moved towards each other too, a certain position control range is maintained.

13. An apparatus according to claim 11 or 12, wherein a component supply and discharge device is provided, which is arranged for placing and removing an electronic component on or from said mold half, respectively.

14. An apparatus according to any one of claims 11-13, wherein a film supply and discharge device is provided for supplying film to the mold cavity and discharging film from the mold cavity.

15. An apparatus according to claims 13 and 14, wherein the film supply and discharge device also forms the component supply device.

16. An apparatus according to any one of claims 11-15, provided with a compound supply provision.

17. An apparatus according to claim 16, wherein the compound supply provision is arranged for supplying the compound to the mold cavity when the mold halves are in the position when moved towards each other.

18. An apparatus according to claim 16, wherein the compound supply provision is arranged for placing the compound on an electronic component which is placed on a mold half.

19. An apparatus according to claim 16, wherein the compound supply provision is arranged for placing compound on an electronic component present outside the mold cavity.

20. An apparatus according to claim 18 or 19, wherein the compound supply provision comprises an inkjet head and a compound reservoir connected to the inkjet head.
